(19) United States
(12) Patent Application Publication
(10) Pub. No.: US 2005/0004956 A1
(43) Pub. Date: Jan. 6, 2005

(54) Optical method for evaluating surface and physical properties of structures made wholly or partially from fibers, films, polymers or a combination thereof

(75) Inventor: Behnam Pourdeyhimi, Cary, NC (US)

Correspondence Address: JENKINS & WILSON, PA, 3100 TOWER BLVD, SUITE 1400, DURHAM, NC, 27707, US

(73) Assignee: North Carolina State University

(21) Appl. No.: 10/612,790

(22) Filed: Jul. 2, 2003

(51) Int. Cl. G06E 1/04

(52) U.S. Cl. 708/191

(57) ABSTRACT

Optical methods for evaluating various surface and physical optical properties of structures made wholly or partially from fibers, polymers, films or a combination thereof. Such methods are comprised of special illumination, special software algorithms and controls that provide a unique solution for evaluating such properties as fiber orientation distribution function, basis weight uniformity, fuzz and pilling, texture, and other physical and surface properties.

### FIELD OF THE INVENTION

The present invention relates to a method for evaluating various surface and physical optical properties of structures made wholly or partially from fibers, polymers, films or a combination thereof.

### BACKGROUND ART

Structures made wholly or partially from fibers, polymers, films or a combination thereof are used in a variety of applications. Most notably, fibers, polymers and films are used in textile structures, nonwovens and coatings. Textile structures are used in apparel, home furnishing, floor covering, and industrial applications. Nonwovens are fiber-based, engineered fabrics used in many similar applications to textile structures as well as medical products, hygiene, baby care, feminine care, homecare and other applications.

The durability of the products is often related to their appearance. For example, in carpets, the carpets are said to ugly out before they are worn out. Similarly, apparel textiles lose their textural attributes due to fabric-to-fabric abrasion which may be manifested in the development of entangled bundles of fibers known as “pills”. Additionally, the uniformity of the appearance may be related to other physical character of the products. For example, in paper and nonwoven products, the blotchiness of the appearance is related to the local variations in mass uniformity known as basis weight non-uniformity. Another example relates to the geometrical arrangement or distribution of elements such as fibers in paper and nonwovens. Such arrangement is referred to as Orientation Distribution Function (ODF) and cannot be readily measured. The determination of these attributes and understanding how such attributes change with use are the subject of many standard test methods which rely on pictorial standards and a panel of human “experts” who will rank the products. It is our belief that such qualitative measurements are invalid and lack precision. While many have attempted to evaluate such attributes automatically, today these subjective measures continue to dominate various industries such as textiles, nonwovens, coatings, automotive coatings and the like. This is in part due to the fact that the solutions previously applied in other fields cannot immediately be used to provide a solution for these structures; each requiring a unique solution.

The present invention is intended to overcome many of the well known deficiencies of prior art and provide a new and improved method for the determination of various physical properties of the structures describe above by optical means. The unique nature of the invention lies in its ability to use common hardware with specific software solutions in a novel combination to provide a complete solution for the measurement of such attributes.

### SUMMARY OF THE INVENTION

Applicant has discovered optical methods and software algorithms to describe various physical attributes of a number of different structures. The present invention comprises a special illumination system, a digitizer (such as a camera) and a computer, all working together with special software that controls illumination, digitization and analysis of the digitized images (pictures) of the substrate being examined. Additionally, the present invention comprises a special algorithm to rank the substrate against known standards by a classification scheme.

The method can be used as a turnkey system where all analysis and measurements are carried out automatically or as a device for generating tables of properties that describe the substrate being examined. The key to the invention is to ensure that appropriate illumination is utilized together with special algorithms that can describe the physical attributes being examined.

It is an object of the present invention to provide an optical method for the evaluation of various physical properties of structures made wholly or partially from fibers, films, polymers or combinations thereof.

It is another object of the present invention to provide means for the determination of basis weight uniformity of structures made wholly or partially from fibers, films, polymers or combinations thereof.

It is another object of the present invention to provide means for the determination of fiber diameter distribution in fibrous products such as nonwovens and paper.

It is another object of the present invention to provide means for the determination of Fiber Orientation Distribution Function (ODF) in fibrous structures such as paper and nonwoven.

It is another object of the present invention to provide means for the determination of texture attributes of fibrous structures such as textiles, carpets, nonwovens as well as non-fibrous structures such as wood, polymer coating, metals and the like.

It is another object of the present invention to provide means for the determination of surface fuzz and pilling in fibrous structures such as nonwovens and textiles.

It is another object of the present invention to provide means for the determination of overall surface appearance of fibrous and non-fibrous structures.

Some of the objects of the invention having been stated other objects will become apparent with reference to the detailed description and the drawings as described herein below.

### DESCRIPTION OF THE DRAWINGS

FIGS. 1A-1D are schematic views of different lighting arrangements for examining samples by transmitting co-axial or directed illumination;

FIGS. 2, 3 and 4 show images of three nonwoven structures (carded polypropylene web, spunbonded polyester nonwoven and polyester staple fiber hydroentangled nonwoven, respectively) obtained by lighting arrangements shown in FIG. 1;

FIGS. 5A-5E show images with known ODF and their DFT transforms;

FIGS. 6A-6C and 7A-7C show typical heavy nonwovens (e.g., 50 gsm polyester spunbonded nonwoven, 100 gsm polyester spunbonded nonwoven and 200 gsm polyester spunbonded nonwoven in FIGS. 6A-6C and 200 gsm polyester spunbonded nonwoven, 200 gsm polypropylene hydroentangled nonwoven and 200 gsm polypropylene needled nonwoven in FIGS. 7A-7C) and their ODF determined by one of applicant's algorithms and also by manual means;

FIG. 8 shows sample images of five nonwovens (all 150 gsm wet-laid polyester nonwovens) with varying degrees of uniformity;

FIGS. 9A -9B show the before and after effect of applying a histogram flattening procedure to a nonwoven (150 gsm wet-laid polyester nonwovens);

FIG. 10 shows a graph of uniformity as a function of sample size for the images shown in FIG. 8;

FIG. 11 shows a graph of uniformity as a function of spatial resolution for images shown in FIG. 8;

FIG. 12 shows a graph of uniformity for the various sample images shown in FIG. 8;

FIGS. 13A-13B are schematic views of two typical low-angle illumination systems for the imaging of fuzz and pill;

FIG. 14 shows images of a knitted cotton fabric obtained by the present invention (top right) and regular diffuse illumination (top left), and with graphs below these images showing the variations in intensity across a scan line demonstrating the degree of contrast obtained by using invention;

FIG. 15 shows images of a knitted cotton fabric obtained by the present invention (top right) and regular diffuse illumination (top left) where the light intensity has been increased when compared to those shown in FIG. 14, and with graphs below these images showing the variations in intensity across a scan line demonstrating the degree of contrast obtained by using the present invention regardless of light intensity;

FIG. 16 shows images obtained by the present invention (right) and regular diffuse illumination (left) for a patterned sample (e.g., a printed woven polyester fabric) demonstrating that the background texture is eliminated by using our invention;

FIG. 17 shows images obtained by the present invention for a sample (e.g., a knitted cotton fabric) rotated in 45 degree increments;

FIG. 18 shows the pill area measured for images shown in FIG. 17 demonstrating the insensitivity of the present invention to sample position;

FIGS. 19A-19B are schematic views of two typical bright field illumination systems for the measurement of texture;

FIG. 20 shows a graph illustrating the features that can be extracted from a texture function;

FIG. 21 shows a graph illustrating the texture range or the distance at which all spatial correlation is lost;

FIG. 22 shows a graph illustrating the texture function for a uniformly periodic and random image;

FIGS. 23A-23B show a graph illustrating a typical texture function (FIG. 23A) and its power spectrum (FIG. 23B); and

FIG. 24 shows a graph illustrating the texture function for a sample of a woven cotton/polyester twill material before and after abrasion.

### DETAILED DESCRIPTION OF THE INVENTION

The invention described herein is a system comprising a lighting or illumination system, a digitization system and a computer. The lighting arrangement and the software algorithms are responsible for the uniqueness of the device. Applicants describe below how various features are measured using the novel system.

### I. Orientation Distribution Function (ODF) in Fibrous Products

In a nonwoven or paper substrate, fiber orientation distribution or ODF ψ is a function of the angle θ. The integral of the function ψ from an angle θ₁ to θ₂ is equal to the probability that a fiber will have an orientation between the angles θ₁ to θ₂. The function ψ must additionally satisfy the following conditions:

$$\begin{matrix}ψ ( θ + π ) = ψ ( θ ) \\ {\int }_{0}^{π} ψ ( θ ) ⅆ θ = 1\end{matrix}$$

For uni-modal distributions, in the range 0 to 180, the peak direction mean is at an angle \overline{α} given by

$$\overline{α} = \frac{1}{2} {tan}^{- 1} \frac{{\sum }_{i = 1}^{N} f ( {α}_{i} ) sin 2 {α}_{i}}{{\sum }_{i = 1}^{N} f ( {α}_{i} ) cos 2 {α}_{i}}$$

while the standard deviation about this mean is given by

$$σ ( α ) = {[ \frac{1}{2 N} {\sum }_{i = 1}^{N} f ( {α}_{i} ) ( 1 - cos 2 ( {α}_{i} - \overline{α} ) ) ]}^{1 / 2}$$

To describe the alignment of the fibers, applicants uses a ratio known as the Anisotropy Ratio, fₚ defined as:

$$\begin{matrix}{f}_{p} = 2 〈 {cos}^{2} θ 〉 - 1 \\ 〈 {cos}^{2} θ 〉 = \frac{{\int }_{0}^{π} ψ ( θ ) {cos}^{2} ( {θ}_{ref} - {θ}_{i} ) ⅆ θ}{{\int }_{0}^{π} ψ ( θ ) ⅆ θ}\end{matrix}$$

The anisotropy parameter varies between −1 and 1. A value for fₚ of 1 indicates a perfect alignment of the fibers parallel to a reference direction and a value of −1 indicates a perfect perpendicular alignment to that direction. fₚ is zero for a random assembly.

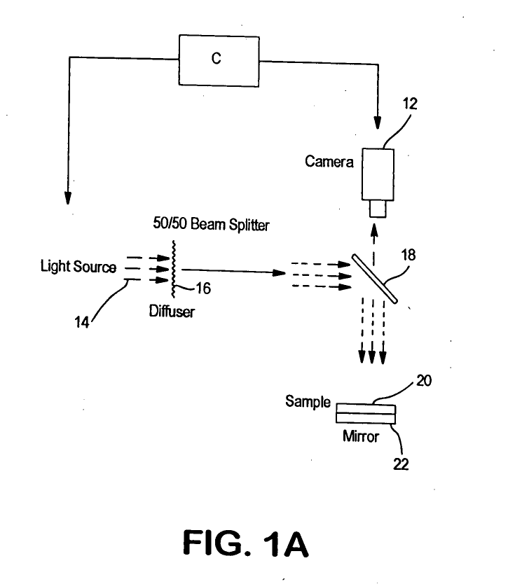

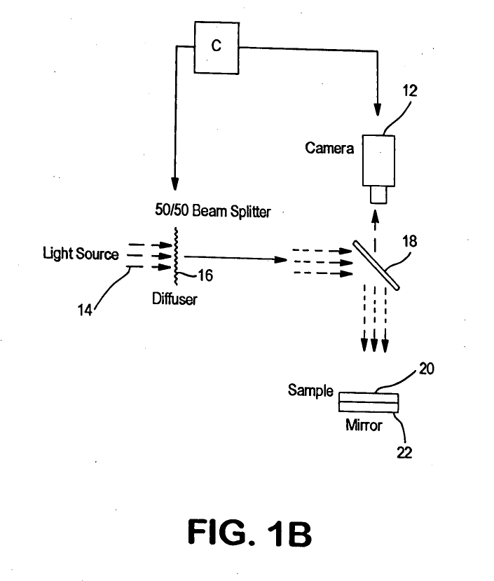

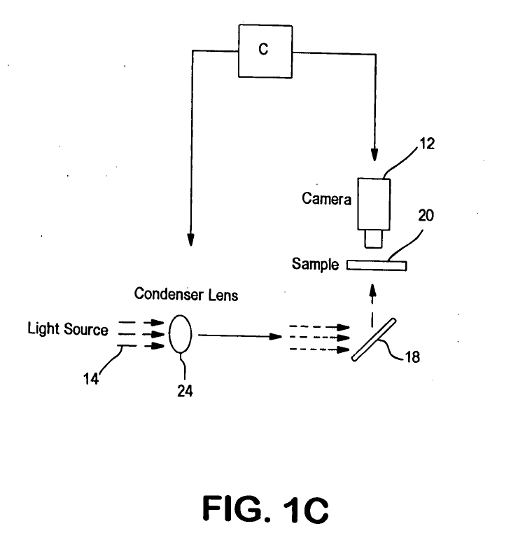

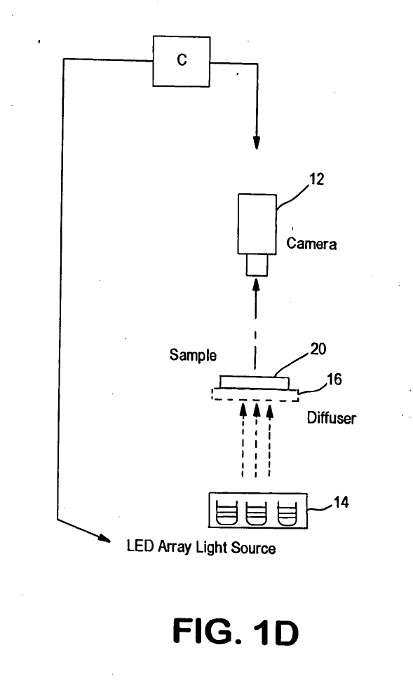

The images of samples being examined using the present process have to possess sufficient contrast and clarity. The lighting arrangements are shown in FIGS. 1A-1D and comprise a camera 12, a light source 14, a diffuser 16, a beam splitter 18, a sample 20, and a mirror 22 (FIGS. 1A-1B); a camera 12, a sample 20, a light source 14, a condenser lens 24, a beam splitter 18 (FIG. 1C); and a camera 12, a sample 20, a diffuser 16, and a light source 14 (FIG. 1D).

Most suitable, camera 12 is an analog SONY CCD or SONY digital camera; light source 14 is a high intensity LED white light source (FIGS. 1A-1D); diffuser 16 is a conventional diffuser known to those skilled in the art; beam splitter 18 is a 50/50 beam splitter; mirror 22 is a first surface mirror; and condenser lens 24 is a double concave lens. Each of the lighting arrangements in FIGS. 1A-1D utilize a computer C connected to camera 12 and light source 14. Arrangements 1C and 1D are the preferred methods.

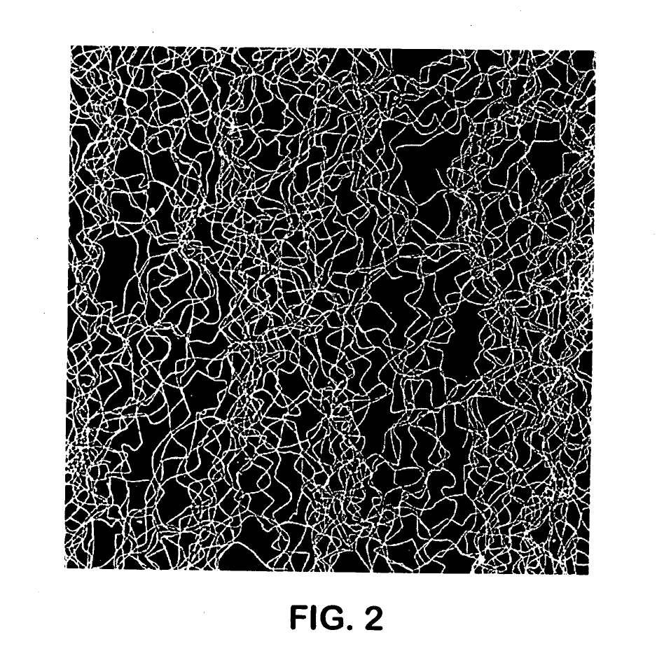

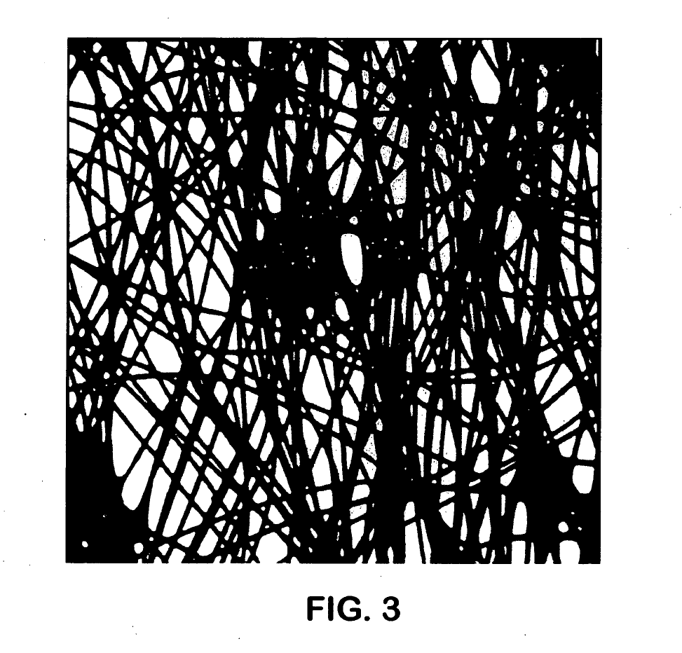

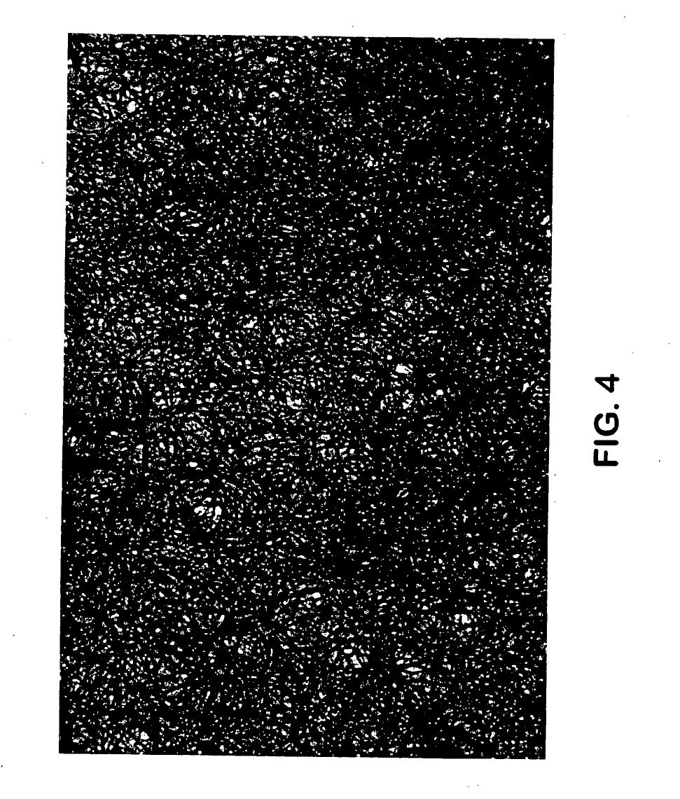

Typical images for various nonwovens (carded polypropylene web; spunbonded polyester nonwoven; and polyester staple hydroentangled nonwoven; respectively) are shown in FIGS. 2, 3 and 4. The sample in FIG. 4 is a heavy nonwoven structure weighing 200 grams per square meter (gsm). The unique feature of these arrangements is that the fibers in multiple layers appear to be in focus and can be used for samples weighing as much as 500 gsm depending upon how densified they are. The ODF can be determined by the present system by various means. Applicant's fiber orientation algorithms are based on:
Fourier Transform
Hough Transform
Direct Tracking
Ridge Tracking

Flow Filed Analysis Applicant prefers the Fourier Transform for determining the orientation distribution features of any image regardless of other features. It requires little or no additional steps in deriving the ODF.

An image may be composed of spatial details in the form of brightness transitions cycling from light to dark and from dark to light. The rate at which these transitions occur is the spatial frequency that is of interest. Spatial frequencies in a nonwoven or paper image are related to the orientation of the fibers; fibers are shown in black on a white background (or vice versa). Of course an image is normally composed of many spatial frequencies that form the complex details of the image.

A frequency domain decomposes an image from its spatial domain of intensities into a frequency domain with appropriate magnitude and phase values. The frequency form of the image is also depicted as an image where the gray scale intensities represent the magnitude of the various frequency components.

There are a number of transform techniques that are routinely used in the field of image analysis. The most common transform method is that of the Discrete Fourier Transform (DFT) or a faster version of the same known as the Fast Fourier transform (FFT). The Fourier transform is useful in determining the frequency of the rate at which intensity transition occurs in a given direction in the image. Thus, if the fibers are predominantly oriented in a given direction in a nonwoven fabric, the rate of change in frequencies in that direction will be low and the rate of change in frequencies in the perpendicular direction will be high. Applicant uses this property of the Fourier transform to obtain information on the fiber orientation distribution in a nonwoven fabric. The Fourier transform of a continuous function f(x), is defined as

$$F ( u ) = {\int }_{- ∞}^{∞} f ( x ) exp ( - j2π ux ) ⅆ x$$

where j=\sqrt{−1}. The inverse Fourier transform is given as:

$$f ( x ) = {\int }_{- ∞}^{∞} F ( u ) exp ( j2π ux ) ⅆ u$$

The power spectrum for the function F(u) is given by
P(u)=|F(u)|²⁼R²(u)+I²(u)
where R(u) and I(u) refer to the real and imaginary components of the function F(u).

In two dimensions, the corresponding direct and inverse Fourier transforms are given as

$$\begin{matrix}F ( u , v ) = {\int }_{- ∞}^{∞} {\int }_{- ∞}^{∞} f ( x , y ) exp [ - j2π ( ux + vy ) ] ⅆ x ⅆ y \\ f ( x , y ) = {\int }_{- ∞}^{∞} {\int }_{- ∞}^{∞} F ( u , v ) exp [ j2 ) ux + vy ) ] ⅆ u ⅆ v\end{matrix}$$

where f(x,y) is the image and F(u,v) is its transform. u refers to the frequency along the x direction while v represents the frequency along the y axis. In discrete form, a continuous function, such as f(x), is discretized into a sequence
{f(x₀),f(x₀+Δx),f(x₀+2Δx), . . . ,f(x_{0+[}N−1]Δx)}
by taking N samples Δx units apart. Thus
f(x)=f(x₀₊kΔx)
where k assumes the discrete values 0, 1, 2, . . . , N−1.
The discrete Fourier transform pair that applies to sampled functions is given by

$$F ( u ) = \frac{1}{N} {\sum }_{x = 0}^{N - 1} f ( x ) exp [ \frac{- j2π ux}{N} ]$$

for u=0, 1, 2, . . . , N, and

$$f ( x ) = \frac{1}{N} {\sum }_{u = 0}^{N - 1} F ( u ) exp [ \frac{+ j2π ux}{N} ]$$

for x=0, 1, 2, . . . , N.
In the two-variable case the Discrete Fourier transform pairs is given by the equations

$$F ( u , v ) = \frac{1}{N} {\sum }_{u = 0}^{N - 1} {\sum }_{v = 0}^{N - 1} f ( x , y ) exp [ \frac{- j2π ( ux + vy )}{N} ]$$

for u=0, 1, 2, . . . , N−1, v=0, 1, 2, . . . , N−1, and

$$f ( x , y ) = \frac{1}{N} {\sum }_{u = 0}^{N - 1} {\sum }_{v = 0}^{N - 1} F ( u , v ) exp [ \frac{+ j2π ( u x + v y )}{N} ]$$

for x=0, 1, 2, . . . , N−1, y=0, 1, 2, . . . , N−1.

Sampling of a continuous function is now in a two-dimensional grid with divisions of width Δx and Δy in the x- and y-axes, respectively. The Fourier spectrum of the discrete functions is the same as that given above except that the independent variables are discrete.

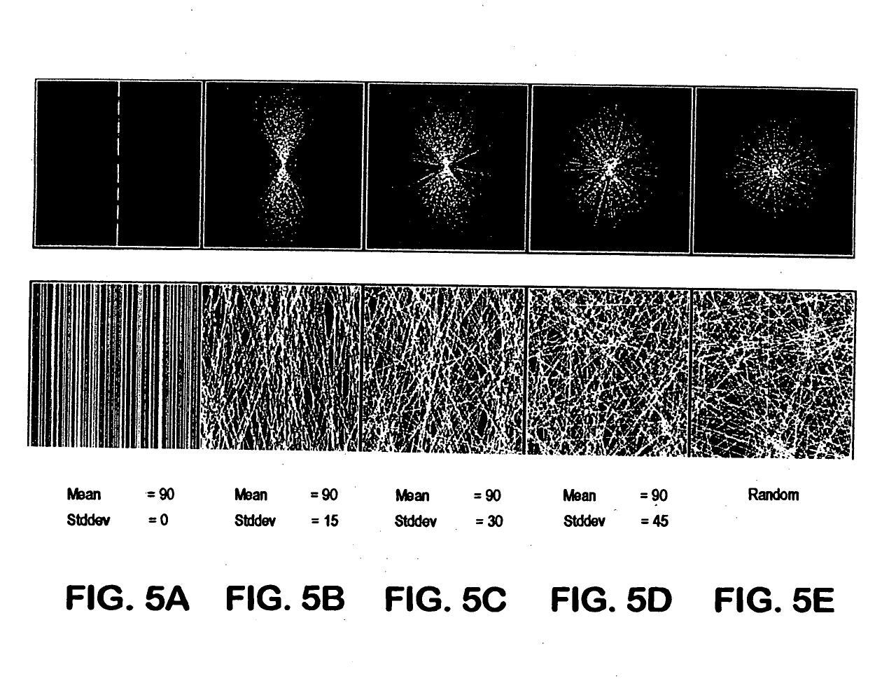

The transform is implemented by processing all rows one at a time followed by all columns one at a time. The result is a two-dimensional set of values with each having a magnitude and a phase. Of interest are the magnitude values. The image magnitude is symmetrical about the center of the image and the center represents the zero-frequency. The magnitude of each frequency is indicated by the intensity of the pixel at that location. Brighter values imply higher frequencies. FIGS. 5A-5E show some typical images with known orientation and their respective transforms. The transforms have been rotated by 90 degrees to align them with the images they represent in terms of orientation. The transform images are in polar coordinates. These transforms have correctly captured the orientation distribution of the images. Since the Fourier transform has its reference in the center, orientations may be directly computed from the transform image by selecting an annulus of width w at a radius from the center of the image and scanning the image radially. An average value of the transform intensity is found for each of the angular cells. Since orientation is limited for fibers to a range of O-π, the results are averaged for that range and its radially symmetric counterpart.

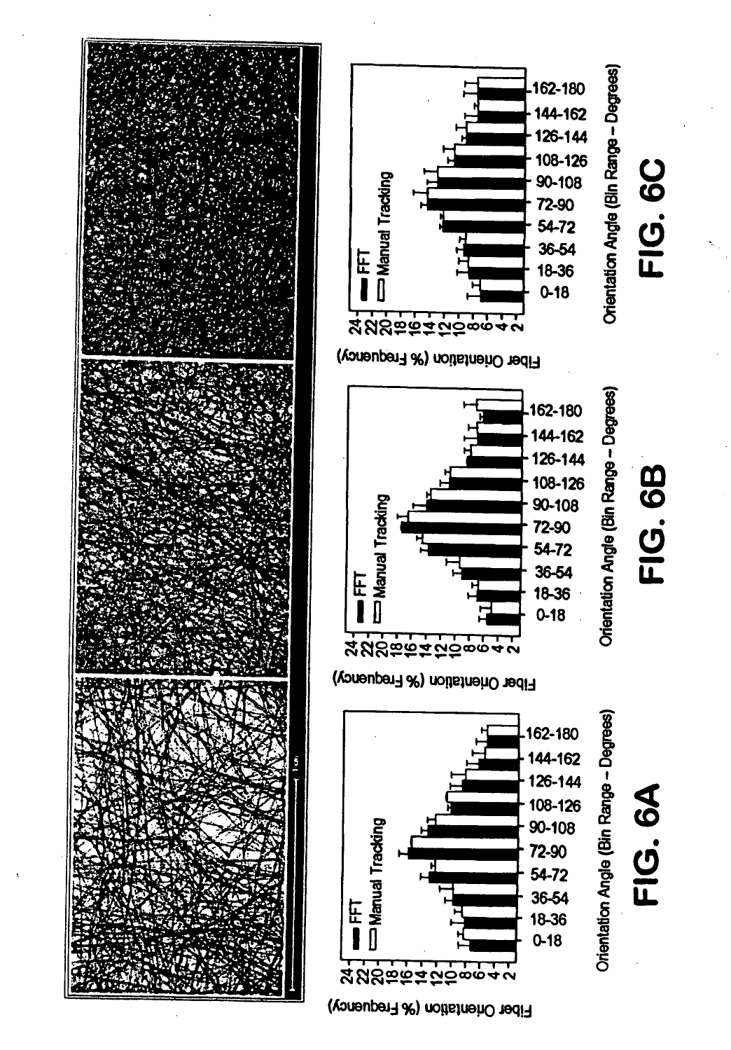

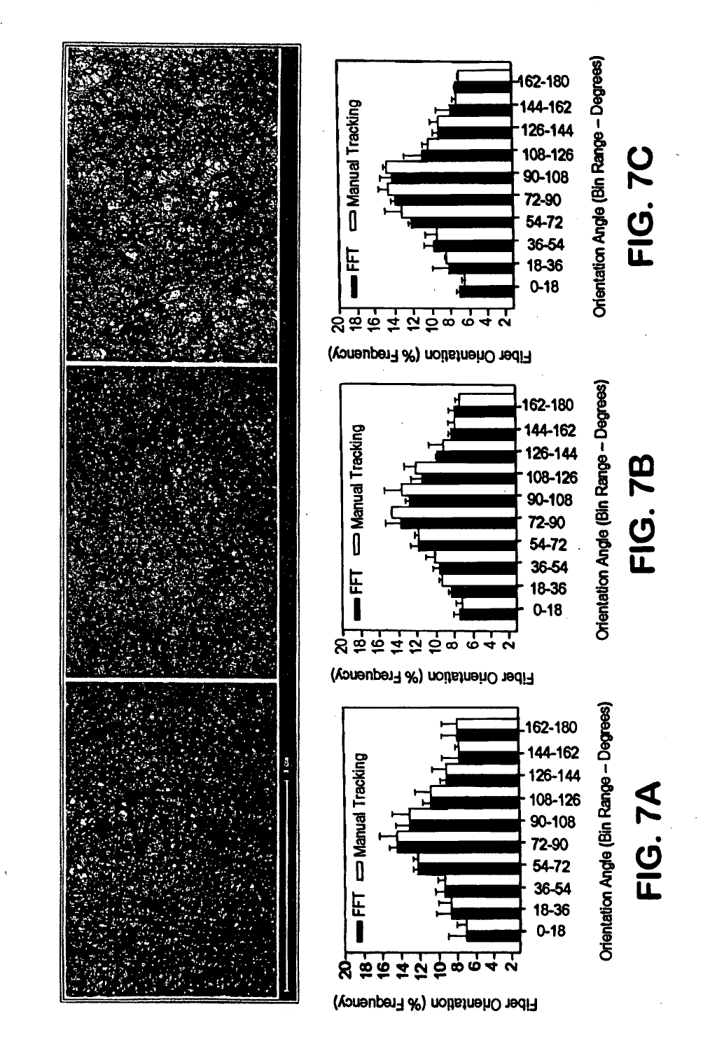

FIGS. 6A-6C show the results for heavy polyester spunbonded nonwovens (e.g., 50 gsm, 100 gsm, and 200 gsm, respectively). These are typically densified structures. The results match those obtained by manually tracking the fibers. The same can be seen in FIGS. 7A-7C for a variety of spunbonded, hydroentangled and needled nonwovens from left to right, respectively (e.g., 200 gsm polyester spunbonded nonwoven, 200 gsm polypropylene hydroentangled nonwoven and 200 gsm polypropylene needled nonwoven). Other algorithms described above result in similar results. However, in the presence of any noise, the Fourier transform will yield more accurate results.

### II. Basis Weight Uniformity in Fibrous Products

Variation of mass (basis weight) in webs, paper and nonwovens has historically been used as an index of uniformity in nonwovens. The method employed often involves the direct measurement of the coefficient of variation of the weight of numerous samples of a given size. A major difficulty in determining the basis weight uniformity lies in the fact that the measurement is often size dependent. That is, the variations occurring at a given size will not be the same as those at another size.

Applicant's motivation is that appearance (optical density) of the sample being examined will correlate with the mass non-uniformity. Mass variations in an image result in the formation of spatial details and specific textures. In other words, the mass variation, when properly illuminated, appears as slowly (spatially) varying signals superimposed by high frequency texture. Since a texture is an image property, its parameters are determined as much by the viewing perspective and resolution of the imaging system as the physical surface it represents. Apropos to this, the applicant is ultimately interested in both how an automated system may process texture information and what features are most important to the eye-brain system of the consumer.

Heuristically, one may ask whether the position of a given unit is predictive of other such units in its vicinity. If the probability of finding another unit is high, the units are said to be clumped or aggregated, if low, their distribution is uniform, and if position is not predictive, the units are distributed in a random fashion. In a nonwoven, it is rather impractical to define a ‘unit’ or an ‘object’. The area being examined must be sufficiently large to be representative of the overall fabric structure. An image of a large section of the fabric will lack spatial resolution and the details of the structure cannot be resolved to define appropriate units. However, since any mass non-uniformity will be reflected in variations in local image intensity, one can resort to methods that determine uniformity for a given area. It is in fact, common in industry to have sensors sample and determine basis weight for areas 1×1 cm or smaller. The problem with this methodology is that the data may not be comparable to that measured say, over a 4×4 cm area. This issue was partly addressed in prior art literature where the mean image intensity and coefficient of variation (CV) of the image brightness was measured for a range of window sizes to create a “non-uniformity spectra”. This type of methodology is not new, however, and is referred to in the literature as the ‘quadrant method’. Quadrant based methods have been used by ecologists for many years to identify an appropriate ‘window size’ for determining uniformity of spatial distributions of plants and animals.

Their data suggested that CV values are high for areas measuring 4 mm² and that they become insensitive to size beyond cell areas greater than 4 mm². While it is expected that the variation will decrease with increasing window size, it is not clear why all samples would display similar behavior for sizes greater than 4 mm². Applicant also has discovered that image average brightness may not be a valid measure of uniformity in a given cell. That is, it is possible for different images to have similar mean intensity values, but may have different degrees of blotchiness. Further, it is not clear what light source was used, how the intensity of the light source was controlled or how the system was calibrated. First order statistics (light intensity distribution, CV, etc.) are clearly affected by the illumination system used and are not reliable at all unless the system as a whole is calibrated. Additionally, video/frame grabber systems have a fixed spatial resolution and the results can therefore be valid for the spatial resolution of the system discussed. The maximum area such a known system would cover was said to have been 8.3 cm² (8.3 square centimeters). Viewing large areas with a macro lens assemblies can also be problematic unless appropriate flat lenses are used. Lastly, the non-uniformity spectra was not used to derive a generalized index of uniformity that would be invariant to size, resolution or illumination.

Regardless of the system used, the issues with the number of samples required and their location pose problems that have to be dealt with as well. Typical density variations range in different spatial dimensions. Thus, the applicant's algorithm must be capable of handling variable spatial resolution.

Applicant has discovered that in determining mass non-uniformity it is critical to obtain a sample large enough to be representative of the overall fabric structure. That is, the area that is being examined for determining non-uniformity must represent the sample in bulk. This is quite different from measuring features such as fiber orientation and fiber diameter that require smaller areas with much higher spatial resolutions. For this study, applicant used a digitizer to obtain images measuring at least 20×20 cm with a light source similar to the arrangement in FIG. 1D. Applicant is using an area measuring 1×1 cm as the smallest area to be considered. Applicant breaks up the image into a number of windows. For each window, applicant records the area fraction (% black in the image) of the fibers. All of the images have the same mean intensity (128). The mean intensity was used to threshold the image. The number of windows is varied by n=i² for i=2, . . . to N. For example, when applicant's sample measures 20×20 cm, the population consists of 400 measurements. If randomness prevails, the Poisson distribution is the appropriate statistical descriptor of the data.

$${P}_{x} = {ⅇ}^{- μ} ( \frac{{μ}^{x}}{x !} )$$

where
Pₓ=Probability of obeserving x individuals
x=An integer counter,; 0, 1, 2, 3, . . .
μ=The true mean of the distribution
x!=(x)(x−1)(x−2) . . . (1) and 0!=1 by definition

This distribution is a discrete frequency distribution that depends only on

$$I = \frac{Observed Variance}{Observed Mean} = \frac{{S}^{2}}{\overline{x}}$$

the mean. This is an approach frequently used in ecology and divides the area of interest into regions of equal area where the expected number of cell counts for a distribution generated by a random process is the mean of the Poisson distribution. This method is commonly referred to as the “quadrant method”. A commonly employed goodness-of-fit test for Poisson data is the index of the observed variance, S², divided by the observed mean, \overline{x}. For data that fit the Poisson distribution, I=1 since the mean and variance are identical. The simplest test statistics for the index of dispersion is chi-square:
X²=I(n−1)
   where
I=Index of dispersion
n=Number of quadrants—see FIG. 2
X²=Value of chi—square with (n−1) degrees of freedom

When the index of dispersion is small (S²<\overline{x}), the distribution is uniform spatially. When the index of dispersion is large (S²>\overline{x}), the distribution is clustered. A random classification (at the 95% confidence interval) is obtained when χ²_{0.975}<observed χ²<χ²_{0.025}. To determine an index describing the chi-square data, applicant divides the data by the total sum of the windows as follows:

$$Uniformity Index = ( 1 - \frac{{\sum }_{i = 2}^{i = n} {χ}_{i}^{2}}{{\sum }_{i = 2}^{i = n} ( {n}_{i} - 1 )} ) \times 100$$

This normalization results in an index between 0 and 100 where 0 would represent the least uniform and 100 the most uniform (least aggregated). The reasons for selecting this method are: a) the algorithm can handle variable spatial resolution and b) it can be used to determine a uniformity index at high speed because the calculations are fast and efficient. This is an important consideration for adapting the method for an on-line application.

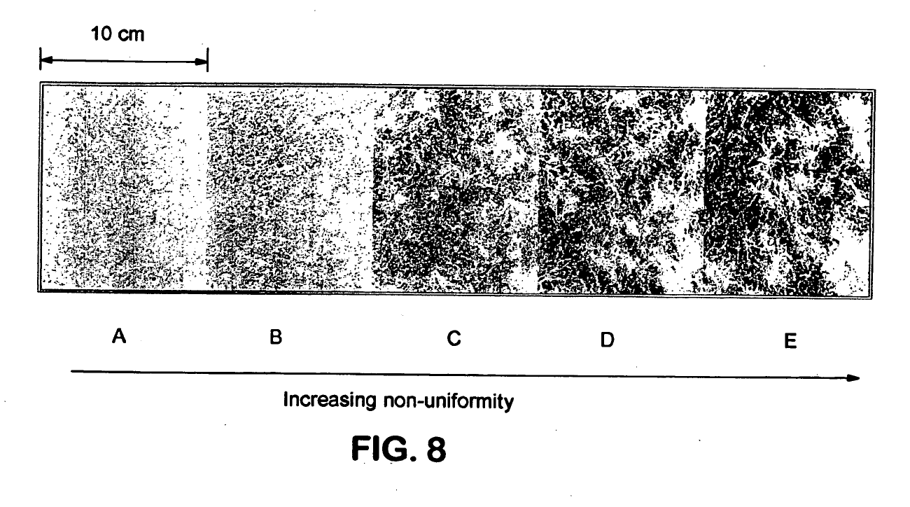

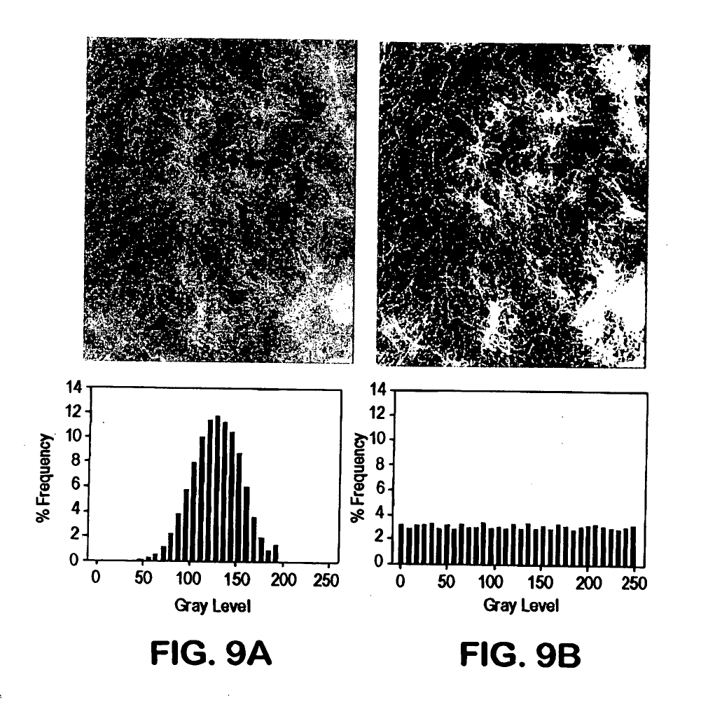

Images used to demonstrate this methodology are shown in FIG. 8 of five wet-laid polyester non-wovens weighing 150 gsm, but with varying degrees of uniformity. These Images measure 10×14 cm. While the digitized images did not require any preprocessing, applicant normalizes the gray level intensities to remove any deviations caused by the adjustment of the illumination system. The procedure applicant uses is one known as the equal probability quantization method commonly referred to as histogram equalization or histogram flattening. The result for one image of wet-laid polyester non-woven weighing 150 gsm is shown in FIGS. 9A-9B before and after histogram flattening. The resulting images will all have the same mean intensity and standard deviation. Note that although the first order statistics are all the same globally after equalization, their local texture (in this case, blotchiness) is preserved. The area fraction of the fibers locally was the measure used in the analysis. One can use any one of a number of second order statistics for this purpose, but applicant chose the area fraction since it is the fastest.

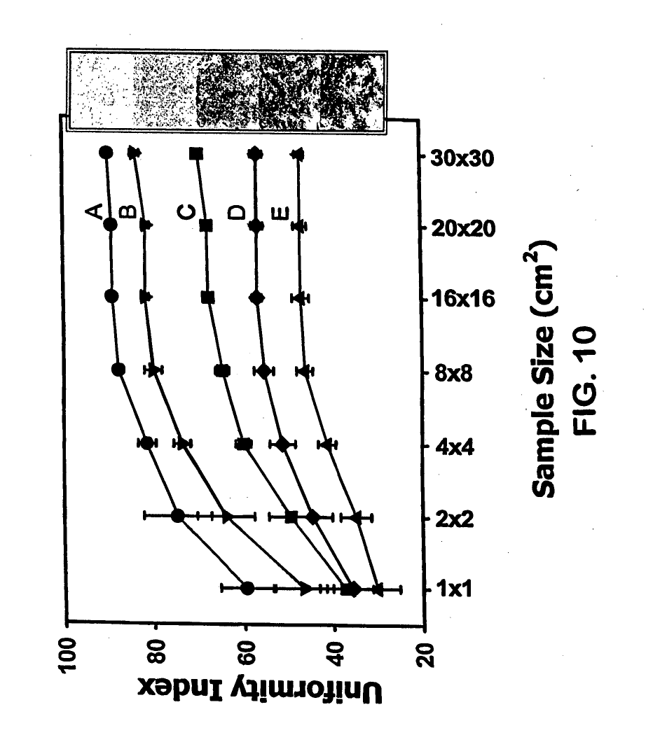

FIG. 10 shows the dependence of the index on the sample size ranging from 1×1 cm to as much 25×25 cm. As may be noted, the index is overestimated for small samples, and in all cases, smaller windows lead to a more non-uniform index assessment. Note also that the standard deviation is greater for small samples and there is much overlap in the data. Consequently, at smaller windows, our ability to separate the samples is lost. However, it appears that regardless of the overall uniformity of the samples, they all seem to yield consistent results beyond sample sizes measuring 10×10 cm or greater. This is very important as it implies that in the present system, samples measuring 10×10 cm may be sufficient for the determination of uniformity.

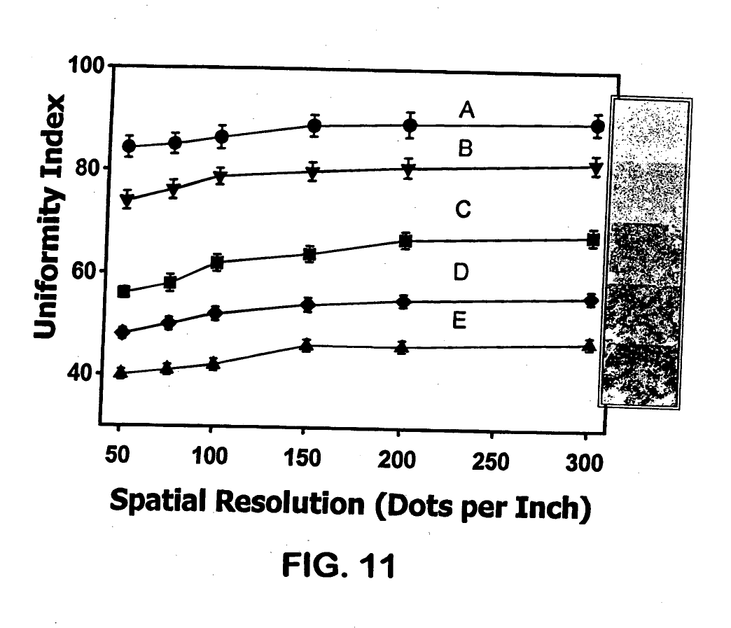

The results for the uniformity index as a function of spatial resolution are shown in FIG. 11. There seems to be a slight increase in uniformity with increasing resolution. The uniformity index, however, becomes invariant to spatial resolution after about 150 dots per inch. Note also that the degree of separation for the various samples at any resolution remains unchanged. This implies that the spatial resolution must be held constant. Additionally, this implies that even at a resolution of 150 dpi, an image measuring 10×10 cm requires an image size of 600×600 pixels. This is well within the range of normal digitizers.

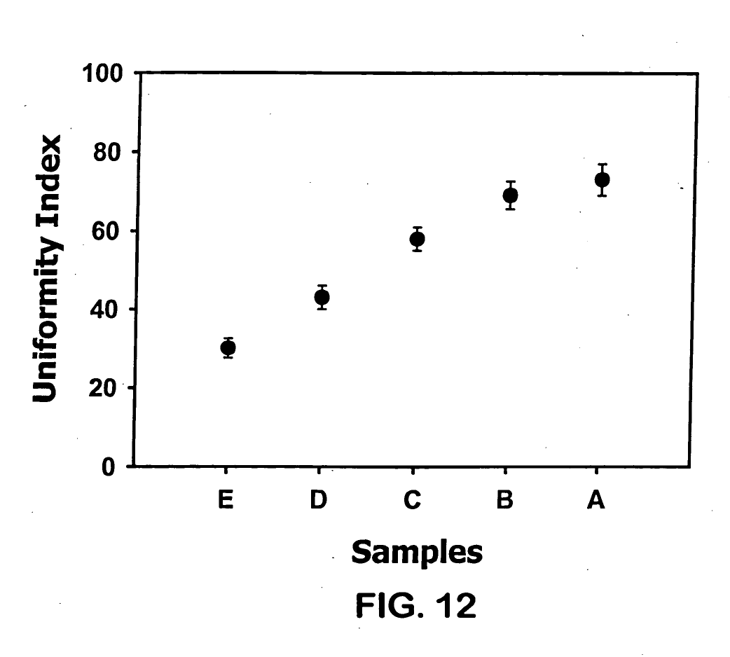

FIG. 12 shows the results for the samples shown in FIG. 8. It is clear that the uniformity is correctly ranked.

### III. Fuzz & Pill in Fibrous Products

In a fibrous media, the formation of fuzz and pill results in a nonuniform texture affecting the uniformity of the appearance. Pilling is a surface flaw in which small bundles of entangled fibers cling to the cloth surface. This is undesirable as it gives the fabric and the garment a worn appearance. Piling is preceded by fuzz formation. Generally, pilling is a characteristic of woven or knitted fabrics while fuzz is more commonly used for nonwovens. In nonwoven fabrics abrasion results in the formation of more non-pillable fuzz than pillable fuzz because of the self-limitation of available fiber length by the presence of the bonds. Furthermore, most nonwoven fabrics often tear long before pills are formed.

Over the past several decades, many test methods have been developed to evaluate pilling, but none can detect pills conveniently and objectively, or describe them comprehensively. Objective and reliable methods are needed to estimate the effects of both fabric structure and abrasion-related variables on fuzz or pill formation.

The present invention again is a combined hardware and software solution that can estimate both fuzzing and piling and is capable of assessing changes easily and reliably. This is accomplished by controlling the angle of the incident light such that only objects raised from the surface are illuminated.

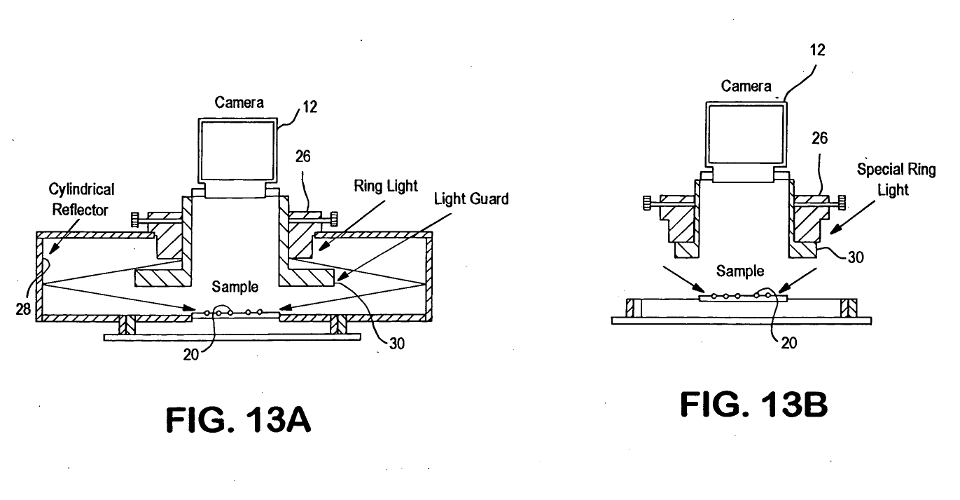

Two representative illumination systems employed are shown in FIGS. 13A-13B. Both lighting arrangements use a ring light 26 (most suitably a high intensity LED light source). The arrangement in FIG. 13A uses a cylindrical reflector 28 to illuminate the sample by transmitting a narrow band of light at the desired lighting angle. The arrangement in FIG. 13B uses a specially designed ring light 26 that transmits the light at the desired shallow angles (preferably between 4° and 60°). In the first arrangement, the light angle and its distribution can be easily adjusted by changing the radius of the cylindrical reflector 28 and/or the distance of the ring light 26 to the sample 20. For purposes of the novel process, in order to minimize the spread of the incident light, a large radius cylindrical reflector (diameter=200 mm) 28 is employed. Additionally, a light guard 30 is employed to restrict the angular range of the incident light. The second arrangement of FIG. 13B is fixed, however. In both cases, the angular spread of the incident light needs to be less than 10 degrees for the system to work effectively. This is essentially a dark field-imaging scheme where very little is reflected by the fabric surface. However, the amount of light scattered by the pills will be relatively high resulting in significant contrast in the final image. This allows easy isolation and quantification of pills without the need for extensive image processing.

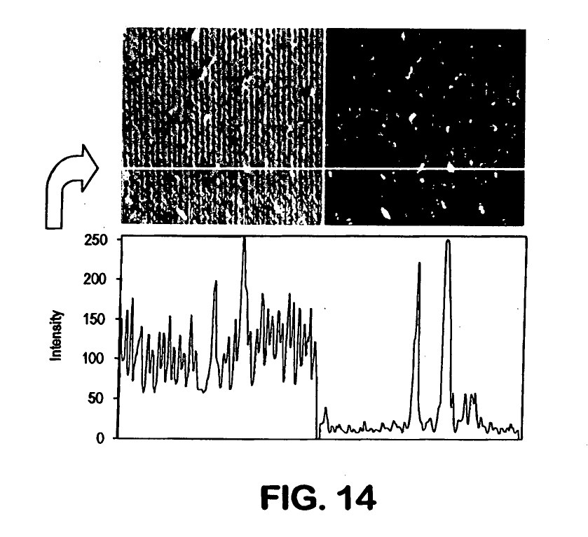

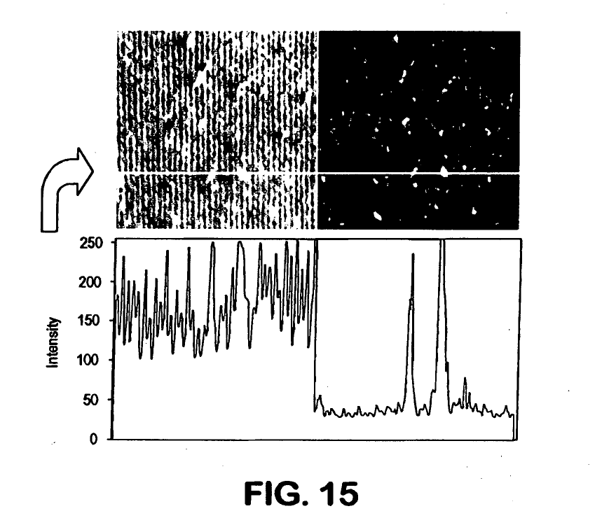

This is demonstrated in FIGS. 14 and 15 where the same abraded area of a knitted cotton fabric is illuminated with diffuse lighting (left) and the cylindrical system (right), respectively. In FIG. 14, the light intensity was adjusted so that the maximum reflected light intensity would be below the maximum intensity level. In FIG. 15, the light intensity was increased further to demonstrate the effect of light intensity on the contrast between the fabric background and the pills. It is immediately clear that the present invention is not significantly affected by the increase in light intensity since the pills are already completely illuminated. In both cases, the cylindrical lighting scheme results in a high contrast between the pills and the background under both light intensities used.

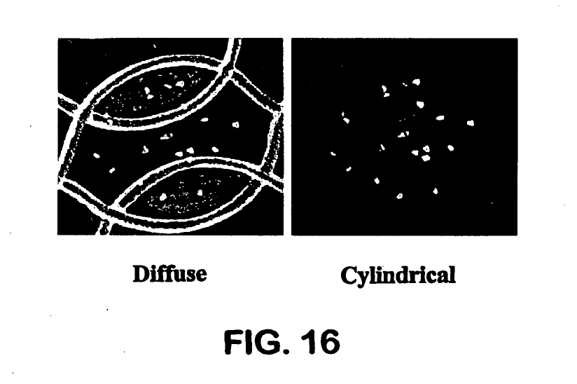

Another complication with lighting arrangements lies in their inability to deal with patterned fabrics. Suppressing the background (fabric pattern and texture) is only possible by employing the present invention. FIG. 16 demonstrates the utility of the invention for a patterned background of a printed woven polyester fabric (a typical woven material). The image on the left was digitized by using a diffuse illumination system and the one to the right used the cylindrical system of the invention.

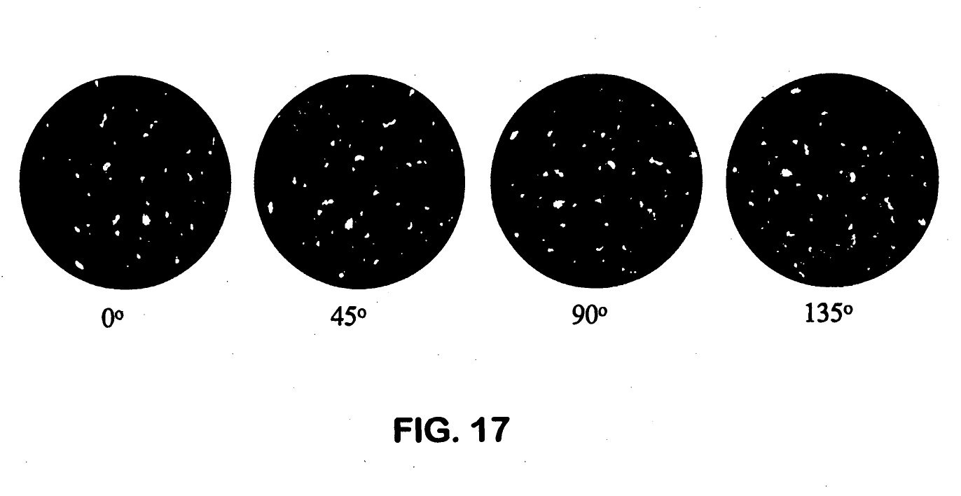

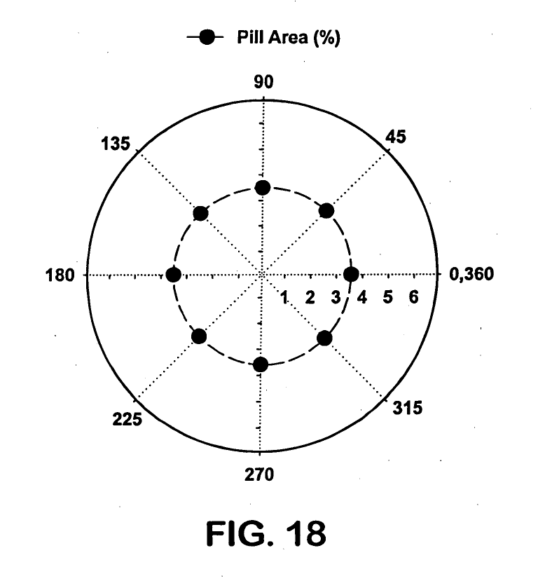

Another advantage of the invention is that it is invariant to sample position because the pills are illuminated circularly. This is important as non-symmetrical and non-planar shapes cast different reflections and different shadows depending on the direction of the incident light. Consequently, the images would appear different depending on the sample position. To determine the sensitivity of the system to sample position, an abraded sample of a knitted cotton fabric is imaged by positioning the samples at angles between 0° and 360° in 45 degree increments relative to the course direction (FIG. 17). The pill area fraction is plotted in FIG. 18 for different sample positions. As expected, the invention exhibits excellent directional stability as the data follow a circular path; any major position dependencies would have resulted in deviations from this circular path.

The present invention contemplates the use of software algorithms that can determine the total area pill area and details of individual pills as well as the overall non-uniformity of the texture brought about by pilling. Current ASTM standards for knitting and weaving are based on subjective comparisons with pictorial standards. The unique nature of the invention is also in its capabilityto relate the measurements of pill area to these standards and determine these rankings automatically and reliably by employing a classification method that relates the attributes measured to those of previously measured known samples (e.g., standards). The classification scheme is common to all of applicant's measurements described herein.

### IV. Texture in Fibrous Products

In applicant's treatment of texture classification and analysis, applicant turns to Rao who proposes three elemental categories of texture organized in the degree of orderliness (strongly ordered, weakly ordered and disordered) of the heterogeneous properties of the surface. Heterogeneous properties refer to variation in patterns or features. Heterogeneous texture descriptors include measures for quantifying periodic variation, the properties of edges or boundaries and flow-like patterns.

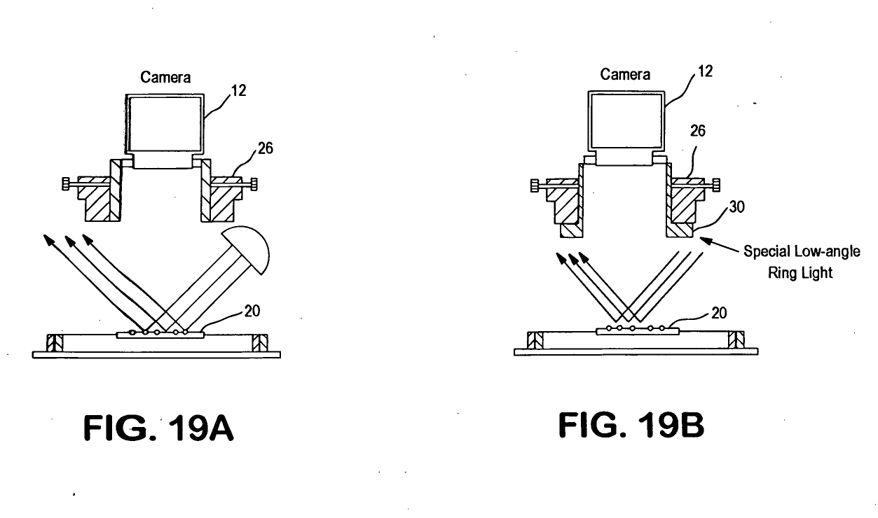

Samples with distinct texture properties will have variations in intensity caused by the surface or the pattern of the color. In most of the materials of concern, the features are the result of a combination of these. That is, the surface will have ridges or raised features, but may also have variations in color. The illumination system should therefore, enable one to detect theses features reliably. Such a system is possible by the two examples shown in FIGS. 19A-19B. In both arrangements, the illumination is such that any raised features will be highlighted and typically at an acute angle between 10° and 80°.

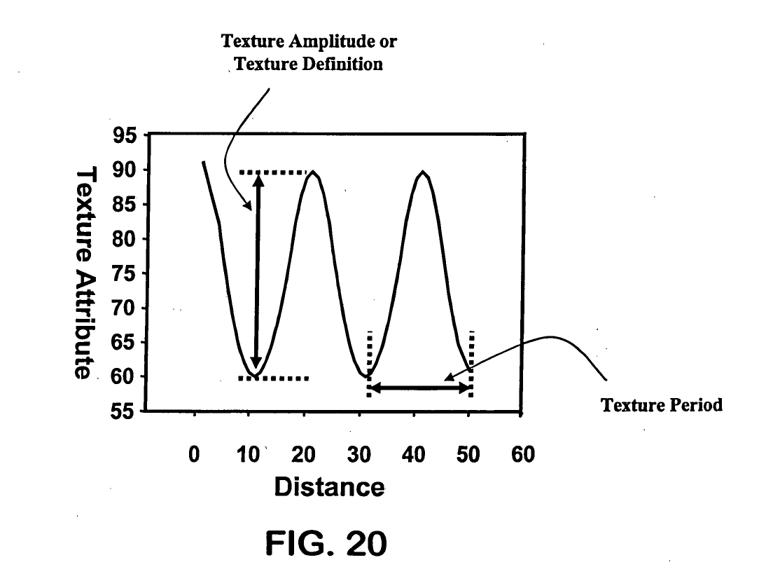

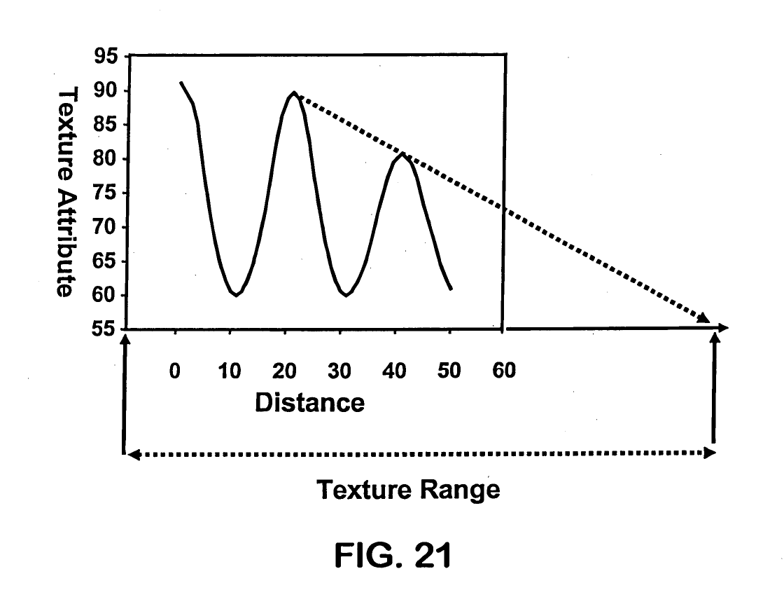

If we follow the path that texture refers to the periodic nature of ‘texture elements’ within the image, then the applicant's algorithms should be able to detect such periodic behavior. FIG. 20 shows a typical texture function where the x-axis depicts the distance and the y-axis depicts the texture attribute that is being measured. It is evident that both texture period and texture definition are features that can describe the texture. Often however, the spatial correlation of the texture units is lost because of the non-uniformity in the spatial location of the texture units. In this case, the texture amplitude will diminish with distance. In other words, texture correlation will be lost with increasing distance. FIG. 21 shows such typical behavior. In this case, the texture range specifies the distance over which the texture correlation is lost.

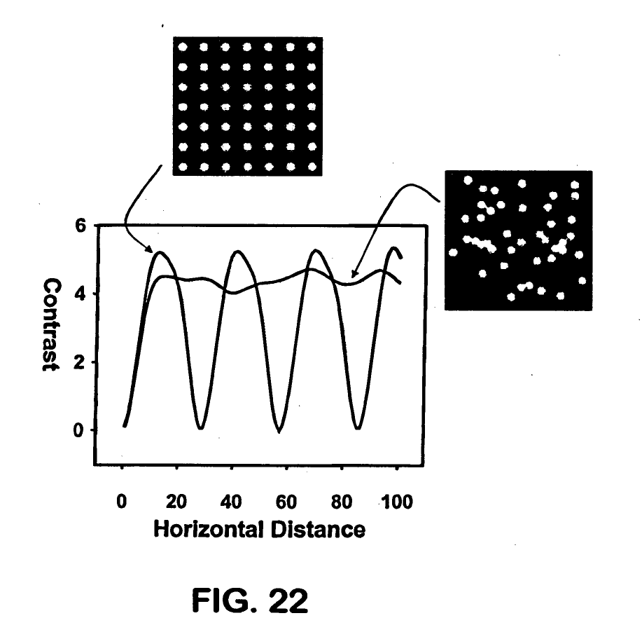

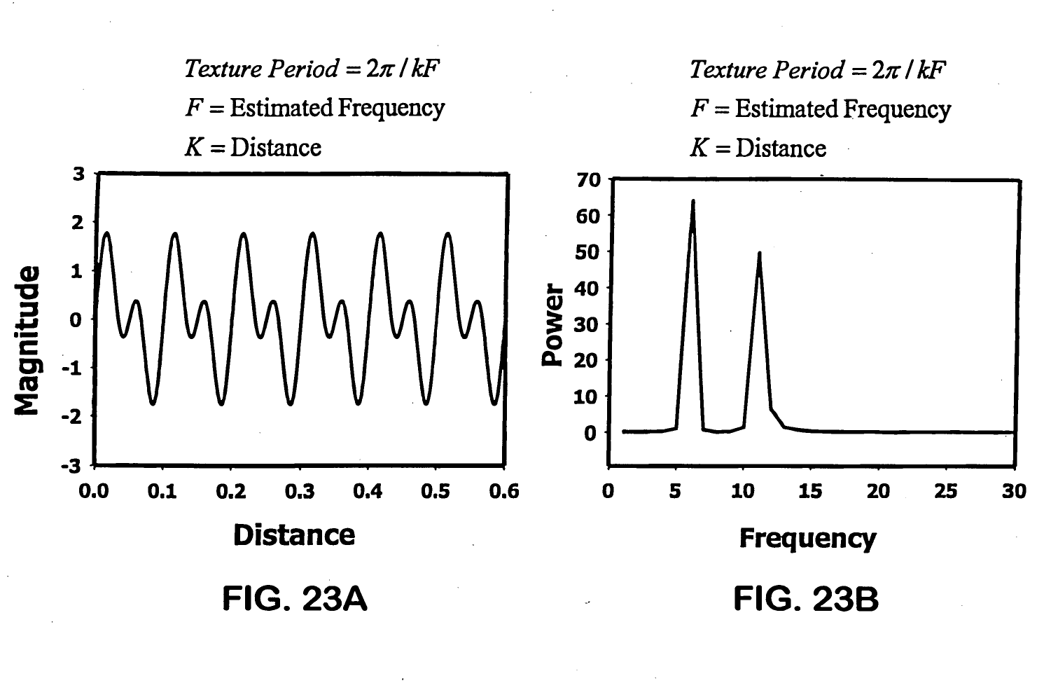

FIG. 22 shows extreme bounds of the texture definition. In one case, the texture is perfectly periodic and in the other, the elements are placed randomly. If the texture is periodic initially and begins to lose its definition, then the texture amplitude will decrease. If the texture units are merged, then it is possible that the texture period may shift as well. To estimate the texture period and its corresponding amplitude, applicant uses Discrete Fourier Transform (DFT) to decompose the texture function. FIGS. 23A-23B show one such result where the initial texture function has two peaks and these are reflected in the two frequencies in the DFT signal. Applicant's algorithm for determining the texture function is based on the second-order, joint-conditional probability density function, f(ij|d,θ) for the probability of sampling a pair of pixel positions with intensity values i and j, separated by distance d in direction θ. Applicant can use several methods to obtain this probability including the spatial gray level dependence method and the gray level difference method, both providing the same output. In practice, applicant systematically samples an image by examining every pixel of an image for which a neighboring pixel exists d units away in direction θ. The intensity of the current pixel, i, and that of its neighbor, j, constitute a single co-occurrence of i and j for given sampling parameters d and θ. The frequencies of all co-occurrences are stored in a matrix, M, of dimensions N by N. Thus, entry i,j in the matrix is the number of i,j pairs sampled in the image. Typically, these frequencies are normalized by the sample size. For a rectangular raster, there are eight directions: 0 (right), 90 (up), 135 (up left), 180 (left), 225 (down left), 270 (down) and 315 (down right).

The degree of spatial correlation will be reflected in the composition of the co-occurrence matrix. If the intensities change over short distances, the frequencies will be spread more evenly across the matrix than if intensities change gradually over distance. A number of statistics can be used to describe the spread, or moment, away from the main diagonal, where i=j. Applicant concentrates here on contrast (otherwise known as inertia), defined as:

$${\sum }_{i = 0}^{n} {\sum }_{j = 0}^{n} \{ {( i - j )}^{2} {M}_{i , j} \}$$

Contrast is a moment statistic and is proportional to the degree of spread away from the main diagonal of matrix M.

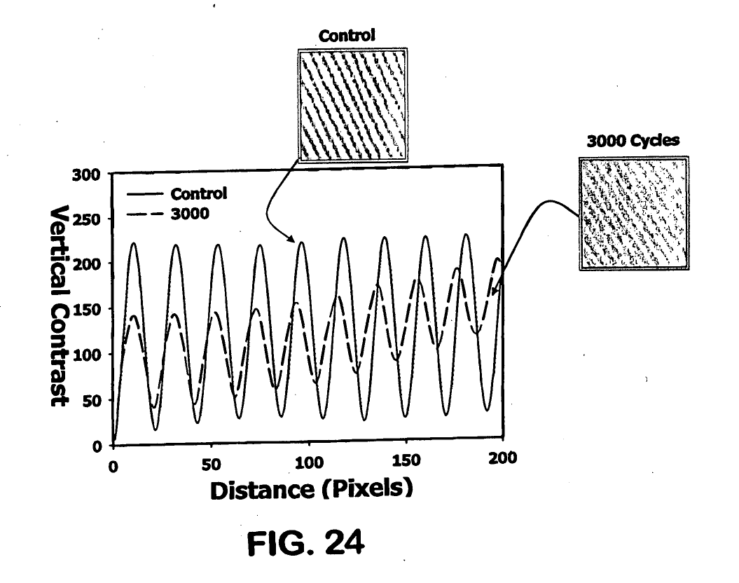

FIG. 24 shows one example where the structure (a woven cotton/polyester twill material) has gone through 3000 abrasion cycles. Note that the texture function amplitude is decreasing with abrasion.

It will be understood that various details of the invention may be changed without departing from the scope of the invention. Furthermore, the foregoing description is for the purpose of illustration only, and not for the purpose of limitation—the invention being defined by the claims.

1. A computer controlled method for evaluating selected surface and physical optical properties of structures made wholly or partly from fibers, polymers, films or a combination thereof, said method comprising the steps of:
(a) illuminating the surface of a structure;
(b) obtaining a digitized image from the illuminated surface of the structure; and
(c) computer processing of the digitized image to determine a property of the structure selected from the group consisting of:
(1) a fiber orientation distribution (ODF) of the fibers on the surface of the imaged structure; (2) basis weight non-uniformity (blotchiness) of the structure; (3) pilling on the surface of the structure; and (4) texture function of the structure.

2. The method according to claim 1 including illuminating the surface of a structure with a direct, collimated, dark-field, or coaxial light source.

3. The method according to claim 1 including obtaining a digitized image from the illuminated surface of the structure with a camera.

4. The method according to claim 1 including creating a fiber orientation distribution (ODF) of fibers on the surface of a structure selected from the group comprising nonwovens, paper and their respective composites.

5. The method according to claim 4 including processing of the ODF to rank the ODF against known standards.

6. The method according to claim 1 including measuring basis weight or structure non-uniformity (blotchiness) of a structure selected from the group comprising webs; papers; and nonwovens and composites made from one or more of these materials.

7. The method according to claim 6 including processing of the basis weight non-uniformity against known standards.

8. The method according to claim 1 including determining pilling on the surface of a structure selected from the group comprising woven and knit constructions.

9. The method according to claim 8 including processing of surface pilling against known standards.

10. The method according to claim 1 including determining texture function of a structure selected from the group comprising woven, knit and non-woven constructions.

11. The method according to claim 10 including processing of the texture function against known standards.

12. A computer controlled method for evaluating selected surface and physical optical properties of structures made wholly or partly from fibers, polymers, films or a combination thereof, said method comprising the steps of:
(a) illuminating the surface of a fibrous structure;
(b) obtaining a digitized image from the illuminated surface of the structure; and
(c) computer processing of the digitized image including use of at least one algorithm selected from the group comprising: Fourier transform; hough transform; direct tracking; ridge tracking; edge tracking and flow filed analysis to create a fiber orientation distribution (ODF) of the fibers on the surface of the imaged fibrous structure.

13. The method according to claim 12 including illuminating the surface of a fibrous structure with a direct, collimated, dark-field, or coaxial light source.

14. The method according to claim 12 including illuminating the surface of a fibrous structure by transmitting light from a light source through a diffuser and a beam splitter onto the fibrous structure supported by a mirror therebeneath to facilitate obtaining the digitized image by a camera positioned above the fibrous structure.

15. The method according to claim 12 including obtaining a digitized image from the illuminated surface of the structure with a camera.

16. The method according to claim 12 including computer processing of the digitized image with a Fourier transform algorithm to create a fiber orientation distribution (ODF) of the fibers on the surface of the imaged fiber structure.

17. The method according to claim 12 including creating a fiber orientation distribution (ODF) of fibers on the surface of fibrous structure selected from the group comprising non-wovens, paper and their respective composites.

18. The method according to claim 13 including processing of the ODF to rank the ODF against known standards.

19. A computer controlled method for evaluating selected surface and physical optical properties of structures made wholly or partly from fibers, polymers, films or a combination thereof, said method comprising steps of:
(a) illuminating the surface of a fibrous structure;
(b) obtaining a digitized image from a structure sample size of at least 10×10 cm²; and
(c) computer processing of the digitized image including breaking the digitize image into windows of at least 1×1 cm for analysis of size effect in order to determine basis weight non-uniformity (blotchiness) of the fibrous structure.

20. The method according to claim 19 including illuminating the surface of the structure with a direct, collimated, dark-field, or coaxial light source.

21. The method according to claim 19 including illuminating the surface of the fibrous structure by transmitting light from a light source through a diffuser and a beam splitter onto the fibrous structure supported by a mirror therebeneath to facilitate obtaining the digitized image by a camera positioned above the fibrous structure.

22. The method according to claim 19 including measuring basis weight or structure non-uniformity (blotchiness) of a structure selected from the group comprising webs; papers; nonwovens and composites made from one or more of these materials.

23. The method according to claim 22 including processing of the basis weight non-uniformity against known standards.

24. A computer controlled method for evaluating selected surface and physical optical properties of structures made wholly or partly from fibers, polymers, films or a combination thereof, said method comprising the steps of:
(a) circularly illuminating the surface of a fibrous structure having pilling thereon by transmitting light at an acute angle of between about 40° and 600° to the surface of the structure to provide dark field imaging of the surface structure wherein little light is reflected by the surface and significant light is reflected by pills and surface defects thereon;
(b) obtaining a digitized dark field image of the surface of the structure; and
(c) computer processing of the digitized image to determine pilling on the surface of the structure.

25. The method according to claim 24 including illuminating the surface of the structure with a direct, collimated or dark-field transmitted light source.

26. The method according to claim 24 including the determining pilling on the surface of a structure selected from the group comprising woven and knit constructions.

27. The method according to claim 26 including processing of surface pilling against known standards.

28. A computer controlled method for evaluating selected surface and physical optical properties of structures made wholly or partly from fibers, polymers, films or a combination thereof; said method comprising the steps of:
(a) illuminating the surface of a fibrous structure by transmitting light at a acute angle thereto between about 10° and 80° in order to highlight raised features on the surface of the structure;
(b) obtaining a digitized image of the structure of the surface; and
(c) computer processing of the digitized image including use of an algorithm to determine texture periodicity and corresponding amplitude in order to determine the texture function of the structure.

29. The method according to claim 28 including illuminating the surface of the structure with a direct, collimated or dark-field transmitted light source.

30. The method according to claim 28 including computer processing of the digitized image with a Fourier transform (FT) to determine the texture function of the substrate.

31. The method according to claim 28 including computer processing of the digitized image with a co-occurrence method to determine the texture function of the substrate.

32. The method according to claim 30 and 31 including computer processing of the digitized image with a Fourier transform (FT) method to determine the texture index or fingerprint of the substrate.

33. The method according to claims 28 including determining texture function of a structure selected from the group comprising woven, knit and non-woven constructions.

34. The method according to claim 33 including processing of the texture function against known standards.
